(19) United States
(12) Patent Application Publication
(10) Pub. No.: US 2017/0257344 A1
(43) Pub. Date: Sep. 7, 2017

(54) BASIC SERVICE SET IDENTIFICATION

(71) Applicants: Po-Kai Huang, West Lafayette, IN (US); Laurent Cariou, Portland, OR (US); Robert J. Stacey, Portland, OR (US)

(72) Inventors: Po-Kai Huang, West Lafayette, IN (US); Laurent Cariou, Portland, OR (US); Robert J. Stacey, Portland, OR (US)

(21) Appl. No.: 15/391,364

(22) Filed: Dec. 27, 2016

Related U.S. Application Data
(60) Provisional application No. 62/303,419, filed on Mar. 4, 2016.

(51) Int. Cl. H04L 29/12; H04W 8/18; H04L 29/08; H04L 5/00

(52) U.S. Cl. CPC H04L 61/6022; H04L 5/0055; H04W 8/18; H04L 69/324; H04W 88/08

(57) ABSTRACT

Methods, apparatuses, computer readable media for basic service set (BSS) identification (ID). An apparatus of a station comprising processing circuitry is disclosed. The processing circuitry is configured to: decode a first frame comprising a first receiver address and a first transmitter address. The processing circuitry may be further configured to classify the first frame as an inter-BSS (inter-BSS) frame or an intra-BSS frame and decode a second frame comprising a second receiver address. The processing circuitry may be further configured to classify the second frame as the inter-BSS frame, if the second receiver address matches the first transmitter address and the first frame is classified as the inter-BSS frame. The processing circuitry may be further configured to classify the second frame as the intra-BSS frame, if the second receiver address matches the first transmitter address and the first frame is classified as the intra-BSS frame.

### PRIORITY CLAIM

This application claims the benefit of priority under 35 USC 119(e) to U.S. Provisional Patent Application Ser. No. 62/303,419, filed Mar. 4, 2016, which is incorporated herein by reference in its entirety.

### TECHNICAL FIELD

Embodiments relate to Institute of Electrical and Electronic Engineers (IEEE) 802.11. Some embodiments relate to high-efficiency (HE) wireless local-area networks (WLANs). Some embodiments relate to IEEE 802.11ax. Some embodiments relate computer readable media, methods, and apparatuses for basic service set (BSS) identification (ID)(BSSID).

### BACKGROUND

Efficient use of the resources of a WLAN is important to provide bandwidth and acceptable response times to the users of the WLAN. However, often there are many devices trying to share the same resources and the devices may interfere with one another. Additionally, the wireless devices may be moving and the signal quality may be changing. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates an overlapping BSS (OBSS) and a BSS in accordance with some embodiments;

FIG. 3 illustrates a clear-to-send (CTS) frame in accordance with some embodiments;

FIG. 4 illustrates an acknowledgement (ACK) frame in accordance with some embodiments;

FIG. 5 illustrates a contention-free (CF) end (CF-end) frame in accordance with some embodiments;

FIG. 6 illustrates a request-to-send (RTS) frame in accordance with some embodiments;

FIG. 7 illustrates a method for BSS ID in accordance with some embodiments;

FIG. 8 illustrates a method for BSS ID in accordance with some embodiments;

FIG. 9 illustrates a method for BSS ID in accordance with some embodiments;

FIG. 10 illustrates a method for BSS ID in accordance with some embodiments;

FIG. 11 illustrates a method for BSS ID in accordance with some embodiments;

FIG. 12 illustrates a method for BSS ID in accordance with some embodiments;

FIG. 13 illustrates a method for BSS ID in accordance with some embodiments;

FIG. 14 illustrates a method for BSS ID in accordance with some embodiments;

FIG. 15 illustrates a method for BSS ID in accordance with some embodiments;

FIG. 16 illustrates a BSSID field in accordance with some embodiments;

FIG. 17 illustrates a method for BSS ID in accordance with some embodiments;

FIG. 18 illustrates a method for BSS ID in accordance with some embodiments;

FIG. 19 illustrates a method for BSS ID in accordance with some embodiments; and

FIG. 20 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

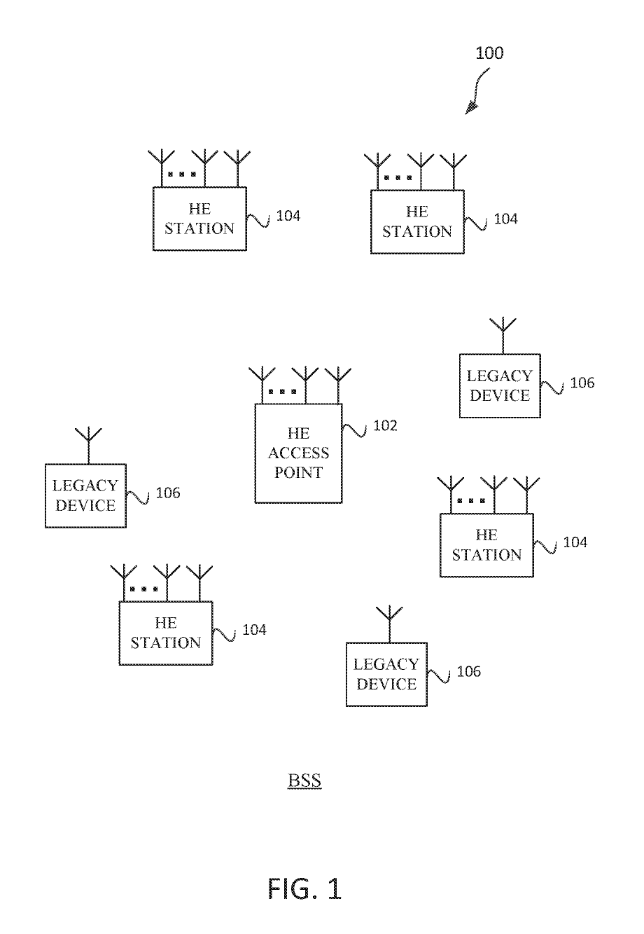

FIG. 1 illustrates a WLAN 100 in accordance with some embodiments. The WLAN 100 may comprise a BSS 100 that may include a HE access point 102, which may be an AP, a plurality of HE stations 104 (e.g., IEEE 802.11ax), and a plurality of legacy (e.g., IEEE 802.11n/ac) devices 106.

The HE access point 102 may be an AP using the IEEE 802.11 to transmit and receive. The HE access point 102 may be a base station. The HE access point 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), code division multiple access (CDMA), space-division multiple access (SDMA), and/or multiple-user multiple-input multiple-output (MU-MIMO). There may be more than one HE access point 102 that is part of an extended service set (ESS). A controller (not illustrated) may store information that is common to the more than one HE access points 102. In some embodiments, the BSS 100 may include a management entity (not illustrated), which may manage one or more BSSs. In some embodiments, the BSS 100 may include a router (not illustrated) that provides access to another network such as the Internet.

The legacy devices 106 may operate in accordance with one or more of IEEE 802.11 a/b/g/n/ac/ad/af/ah/aj/ay, or another legacy wireless communication standard. The legacy devices 106 may be stations or IEEE stations. The HE stations 104 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE stations 104 may be termed stations, HE stations, or stations (STAs).

The HE access point 102 may communicate with legacy devices 106 in accordance with legacy IEEE 802.11 communication techniques. In example embodiments, the HE access point 102 may also be configured to communicate with HE stations 104 in accordance with legacy IEEE 802.11 communication techniques.

In some embodiments, a HE frame may be configurable to have the same bandwidth as a channel. The HE frame may be a physical (PHY) layer convergence procedure (PLCP) protocol data unit (PPDU). In some embodiments, there may be different types of PPDUs that may have different fields and different physical layers and/or different media access control (MAC) layers. In some embodiments, there may be different PPDU formats for different communication standards, e.g., a non-high-throughput (HT) PPDU for IEEE 802.11a, HT PPDU for IEEE 802.11n, very HT (VHT) PPDU for IEEE 802.11ac, or HE PPDU for IEEE 802.11ax.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz, 40 MHz, 80 MHz, 160 MHz, or 320 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, a 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE frame may be configured for transmitting a number of spatial streams, which may be in accordance with MU-MIMO and may be in accordance with OFDMA. In other embodiments, the HE access point 102, HE STA 104, and/or legacy device 106 may also implement different technologies such as CDMA 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11 embodiments, e.g, IEEE 802.11ax embodiments, a HE access point 102 may operate as a HE access point which may be arranged to contend for a wireless medium (e.g., during a contention period) to receive exclusive control of the medium for an HE control period. In some embodiments, the HE control period may be termed a transmission opportunity (TXOP). The HE access point 102 may transmit a HE trigger frame, at the beginning of the HE TXOP. The HE access point 102 may transmit a time duration of the TXOP, RU information, etc. During the HE TXOP, HE STAs 104 may communicate with the HE access point 102 in accordance with a non-contention based multiple access technique such as OFDMA or MU-MIMO. This is unlike conventional WLAN communications in which devices communicate in accordance with a contention-based communication technique, rather than a multiple access technique. During the HE TXOP, the HE access point 102 may communicate with HE stations 104 using one or more HE frames. During the HE TXOP, the HE stations 104 may operate on a channel smaller than the operating range of the HE access point 102. In some embodiments, the trigger frame may indicate one or more RUs which may be contention based for HE stations 104 and/or HE access point 102 during the TXOP. During the HE TXOP, legacy stations refrain from communicating. The legacy stations may need to receive the communication from the HE access point 102 to defer from communicating.

In accordance with some embodiments, during the HE TXOP the HE stations 104 may contend for the wireless medium with the legacy devices 106 being excluded from contending for the wireless medium during the HE TXOP. In some embodiments the trigger frame may indicate an UL MU-MIMO and/or UL OFDMA TXOP. In some embodiments, the trigger frame may include a DL MU-MIMO and/or DL OFDMA with a schedule indicated in a preamble portion of trigger frame for the HE stations 104 to decode the DL data and/or frame.

In some embodiments, the multiple-access technique used during the HE TXOP may be a scheduled OFDMA technique, although this is not a requirement. In some embodiments, the multiple access technique may be a TDMA technique, FDMA technique, SDMA, and/or CDMA.

The HE access point 102 may also communicate with legacy stations 106 and/or HE stations 104 in accordance with legacy IEEE 802.11 communication techniques. In some embodiments, the HE access point 102 may also be configurable to communicate with HE stations 104 outside the HE TXOP in accordance with legacy IEEE 802.11 communication techniques, although this is not a requirement.

In some embodiments the HE station 104 may be a “group owner” (GO) for peer-to-peer modes of operation. A wireless device may be a HE station 102 or a HE access point 102. In some embodiments, the HE station 104 and/or HE access point 102 may be configured to operate in accordance with IEEE 802.11mc. In some embodiments, one or more IEEE 802.11 communication standards may be termed WiFi®. A HE station 104 and/or HE access point 102 may be termed an HE device (e.g., station or AP), if the HE device complies with wireless communication standard IEEE 802.11ax. In some embodiments, the HE stations 104 may have limited power. In some embodiments, the HE stations 104 may have limited power and may transmit on an RU less than 20 MHz in order to reach the HE access point 104.

In example embodiments, the HE station 104 and/or the HE access point 102 are configured to perform the methods and functions described herein in conjunction with FIGS. 1-20.

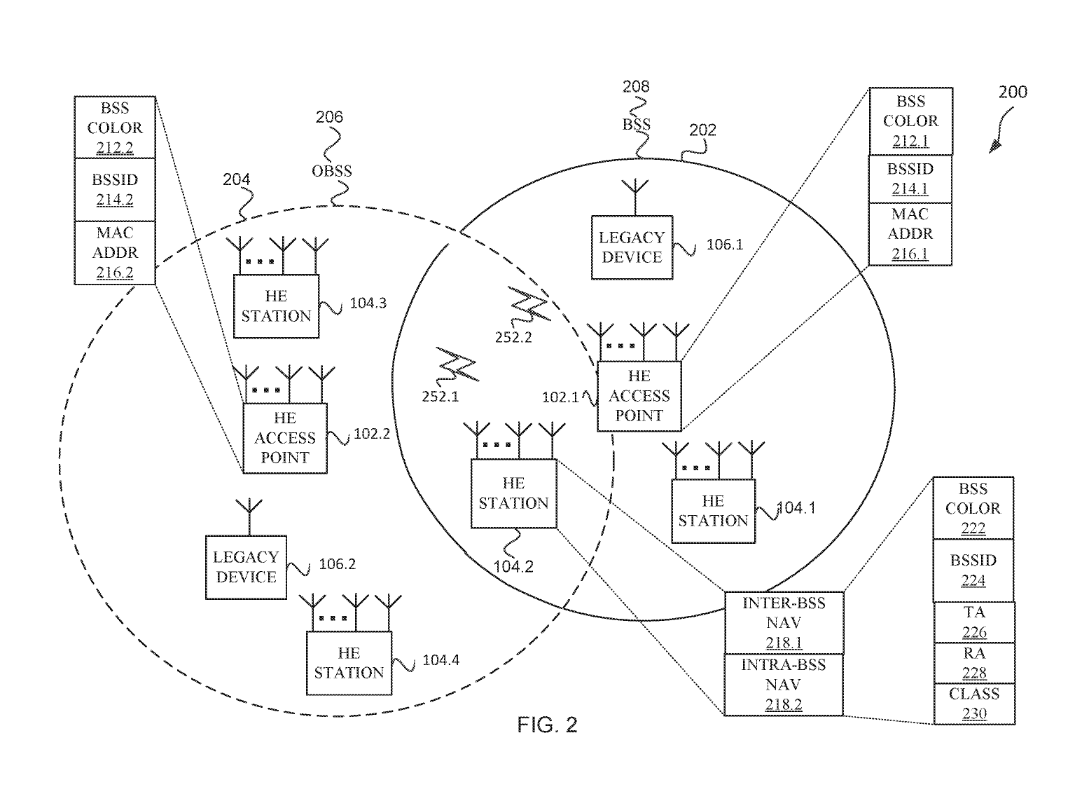

FIG. 2 illustrates an overlapping BSS (OBSS) 206 and a BSS 208 in accordance with some embodiments. Illustrated in FIG. 2 is transmit distance 202 of BSS 208, transmit distance 204 of OBSS 206, OBSS 206, BSS 208, and communications 252. Transmit distance 202 and transmit distance 204 may indicate a range beyond which the signals of the HE access point 102.2 and HE access point 102.1, respectively, will be received at below a minimum received power. BSS 208 and OBSS 206 may be BSSs 100 as described in conjunction with FIG. 1. HE station 104.1, HE station 104.2, and legacy device 106.1 may be associated with HE access point 102.1. HE station 104.3, HE station 104.4, and legacy device 106.2 may be associated with HE access point 102.2. Communication 252.1 and 252.2 may be from HE access point 102.2, HE station 104.3, HE station 104.3, or legacy device 106.2.

In some embodiments, OBSS 206 and BSS 208 may have different BSS colors 212. HE access point 102 and/or HE stations 104 may store BSS color 212.2, in accordance with some embodiments. The OBSS 206 and BSS 208 may have a BSSID 214, e.g., the BSSID for OBSS 206 may be a media access control (MAC) address MAC address (ADDR) 216.2 of the HE access point 102.2, and BSSID 214.1 of BSS 208 may be a MAC address 216.1 of HE access point 102.1. The BSS color 212 and/or BSSID 214 may be included in communications 252. The BSSID 214 may be a 48 bit ID.

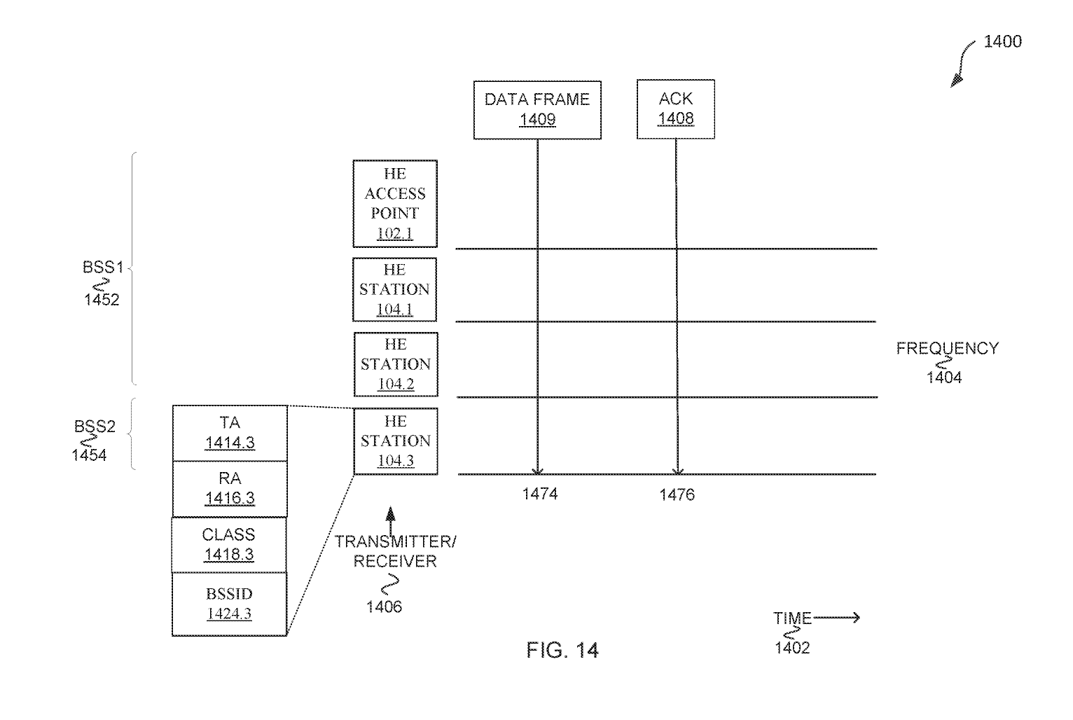

The communications 252 may each be a PPDU, e.g., HE extended range (ER) single user (SU) PPDU, HE SU PPDU, HE trigger-based PPDU, or HE MU PPDU. The communications 252 may be a CTS frame 300, ACK frame 400, CF-End 500 frame, data frame 1409 (FIG. 14), frame 1309, data 1 1508, data 2 1510, or an RTS frame 600.

The HE stations 104 may maintain one or more network allocation vectors (NAVs), e.g., inter-BSS 218.1 and intra-BSS NAV 218.2. Inter-BSS 218.1 and/or intra-BSS NAV 218.2 may have a BSS color 222, BSSID 224, transmitter address (TA) 226 field, receive address (RA) 228 field, and classification (class) 230 of previous frame associated with the NAV 218. The HE station 104 and/or HE access point 102 may be configured to store information (e.g., BSS color 222, BSSID 224, TA 226, TA 228, and/or classification 230) from a communication 252 when the HE station 104 and/or HE access point 102 sets a NAV 218 based on the frame. The HE station 104 and/or HE access point 102 may be configured to store information (e.g., BSS color 222, BSSID 224, TA 226, TA 228, and/or classification 230), when the HE station 104 and/or HE access point 102 receives a communication 252. The information may be used to assist in determining whether subsequent frames are inter-BSS or intra-BSS frames, and/or used to determine whether a previously received frame is an inter-BSS or intra-BSS frame based on subsequent frames.

The HE stations 104 may maintain BSS color 212 of the BSS they are associated with, BSSID 214 of the HE access point 102 they are associated, and/or a MAC address 216 of the HE access point 102 the HE station 104 is associated with.

In some embodiments, when an HE station 104 receives a frame, if one address in the frame matches a BSSID 214 of the HE access point 102 the HE station 104 is associated with, then the HE station 104 classifies the frame as an intra-BSS frame. When none of the addresses of the frame match the BSSID 214 of the HE access point 102 the HE station 104 may use one or more of the methods disclosed herein to determine if the frame is an inter or intra BSS frame.

The HE stations 104 and/or HE access points 102 may determine whether or not a communication 252 needs to be considered based on a received energy level or a received PHY header of a frame (e.g., communication 252).

HE access point 102 and HE stations 104 may determine whether communications 252 is from an OBSS 206 HE access point 102 or HE station 104, or from a BSS 208 HE access point 102 or HE station 104 based on a preamble and/or MAC portion of the communication 252, e.g., based on a BSSID, MAC address, BSS color, and/or based on previous communications 252 as disclosed herein.

For example, HE station 104.2 may determine that a communication 252.1 is from BSS 208 because the value of the BSS color 212 field is equal to the value of the BSS color 212.1 field of the BSS 208 of HE station 104.2. As another example, HE station 104.2 may determine that a communication 252.1 is from an OBSS (e.g., OBSS 206) because the value of the BSS color 212 field is not equal to the value of the BSS color 212.1 field of the BSS 208 of the HE station 104.2.

In some embodiments, there may be more than one HE access points 102 associated with a BSS color 212 and/or BSSID 214, and the more than one HE access points 102 may be communicatively coupled through a management entity (not illustrated), e.g., a management entity that is part of a router and/or a management entity that is part of backend server that is connected to the BSS 208 via the Internet.

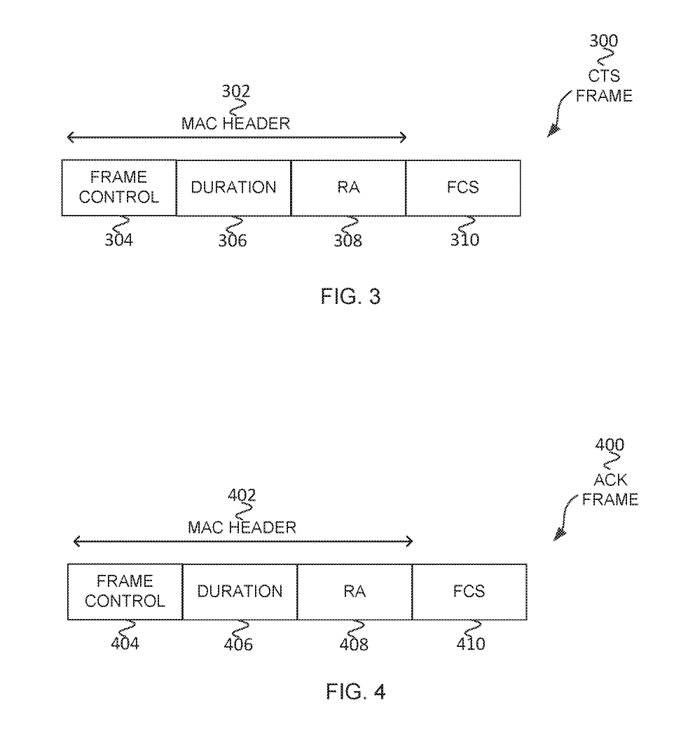

FIG. 3 illustrates a clear-to-send (CTS) frame 300 in accordance with some embodiments. The CTS frame 300 may include a MAC header 302 and a frame control sequence (FCS) 310 field. The MAC header 302 may include a frame control 304, a duration 306, and a RA 308. The frame control 304 may include information about the CTS frame 300 such as the type of the frame. The duration 306 may be a remain duration of a transmission opportunity. The RA 308 field may have an intended receiver address.

The FCS 310 may include information for detecting and correcting errors in the CTS frame 300. The CTS frame 300 includes a PHY header (not illustrated). The HE access point 102 and/or HE station 104 may be configured to encode and decode the Ack frame 400.

FIG. 4 illustrates an acknowledgement (Ack) frame 300 in accordance with some embodiments. The Ack frame 400 may include a MAC header 402 and a FCS 410 field. The MAC header 402 may include a frame control 404, a duration 406, and a RA 408. The frame control 404 may include information about the ACK frame 400 such as the type of the frame. The duration 406 may be a remain duration of a transmission opportunity. The RA 408 field may have an intended receiver address.

The FCS 410 may include information for detecting and correcting errors in the ACK frame 400. The Ack frame 400 includes a PHY header (not illustrated). The HE access point 102 and/or HE station 104 may be configured to encode and decode the CTS frame 300.

FIG. 5 illustrates a contention-free (CF) end (CF-end) frame 500 in accordance with some embodiments. The CF-end frame 500 may include a MAC header 502 and a FCS 512 field. The MAC header 502 may include a frame control 504, a duration 506, a RA 508, and a BSSID (TA) 510. The frame control 504 may include information about the CF-End 500 such as the type of the frame. The duration 506 may be set to 0 to indicate that a contention free period or transmission opportunity is over. The RA 508 field may have an intended receiver address, which may be a group address. The BSSID (TA) 510 field may be an address of an intended receiver. The BSSID (TA) 510 may include an individual/group bit.

The FCS 512 may include information for detecting and correcting errors in the CF-End frame 500. The CF-end frame 500 includes a PHY header (not illustrated). The HE access point 102 and/or HE station 104 may be configured to encode and decode the CF-End frame 500.

In some embodiments a HE station 104 that receives a CF-end 500 will not reset its NAV (e.g., inter-BSS NAV 218 or intra-BSS NAV 220) if one of the following is true. First, the CF-end 500 did not originate from the HE station's 104 (e.g., 104.2) associated BSS 208 or any BSS of a multi-BSSID set that the HE station 104.2 associated BSS 208 belongs to and the most recent NAV (e.g., inter-BSS NAV 218 or intra-BSS NAV 220) update of the HE station 104 was due to a communication 252 (e.g., PPDU) originating from the HE station 104.2 associated BSS 208 or any BSS of a multi-BSSID set that the HE station's 104.2 associated BSS 208 belongs to.

Second, the CF-End 500 originated from the HE station 104.2 associated BSS 208 or any BSS of a multi-BSSID set that the HE station's 104.2 associated BSS 208 belongs to and the most recent NAV (e.g., inter-BSS NAV 218 or intra-BSS NAV 220) update was not due to a communication (e.g., PPDU) 252 originating from the HE station's 104.2 associated BSS 208 or any BSS of a multi-BSSID set that the HE station's 104.2 associated BSS 208 belongs to.

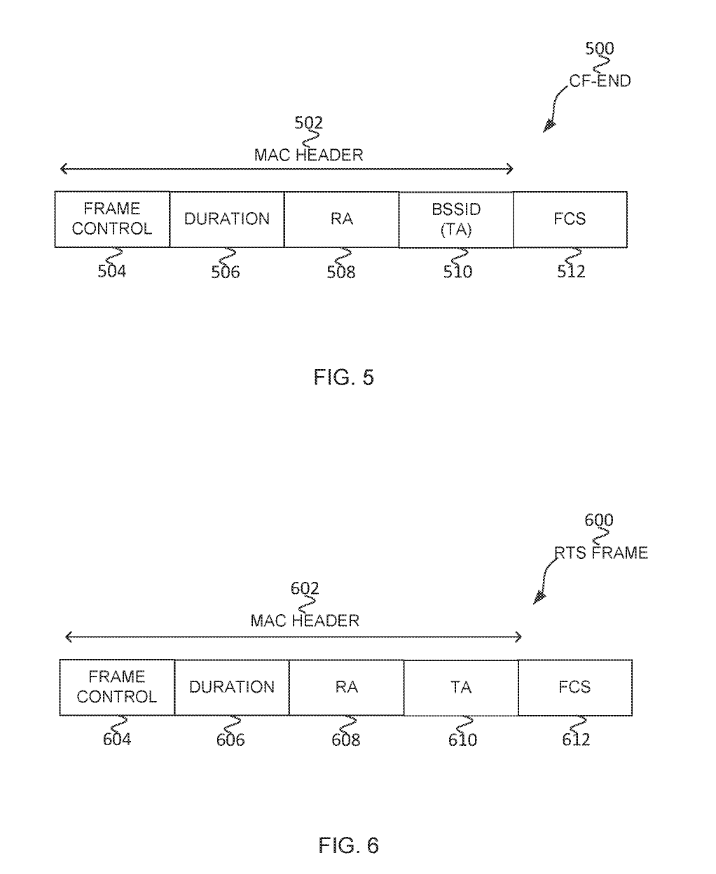

FIG. 6 illustrates a request-to-send (RTS) frame 600 in accordance with some embodiments. The RTS-end frame 600 may include a MAC header 602 and a FCS 510 field. The MAC header 602 may include a frame control 604, a duration 606, a RA 508, and a TA 610. The frame control 604 may include information about the RTS frame 600 such as the type of the frame. The duration 606 may be a remaining duration of a transmission opportunity. The RA 608 field may have an intended receiver address, which may be a group address. The TA 610 field may have a transmitter address of the RTS frame 600. In some embodiments, the TA 610 may include a signaling bit that is not part of the MAC address of the transmitting station/access point, e.g., group/multicast bit. In some embodiments, when the group/multicast bit is set the TA may be termed a bandwidth signaling TA. In some embodiments, the HE station 104 and/or HE access point 102 may be configured to detect if a signaling bit is set and to reset the bit when the TA 610 is stored associated with a NAV 218, e.g., TA 226, or when the TA is stored (e.g., TA 1414) to assist in determining whether a frame is an inter-BSS or intra-BSS frame.

The FCS 612 may include information for detecting and correcting errors in the RTS frame 600. The RTS frame 600 includes a PHY header (not illustrated). The HE access point 102 and/or HE station 104 may be configured to encode and decode one or more of the frames disclosed herein (e.g., the CF-End frame 500.)

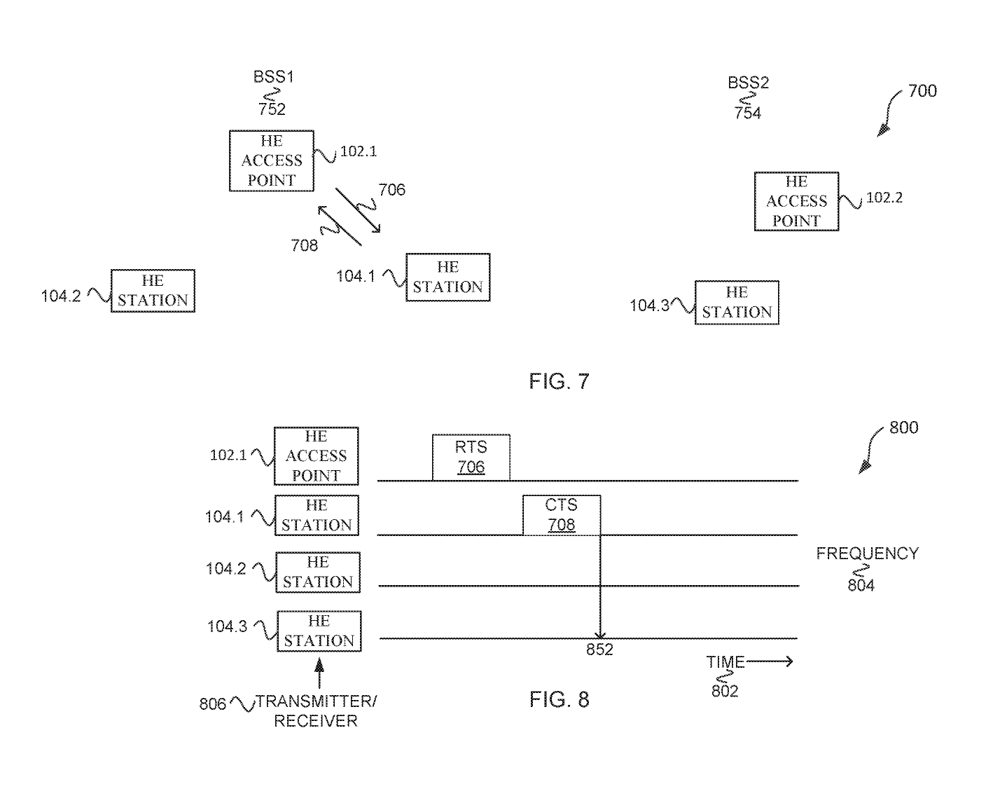

FIG. 7 illustrates a method 700 for BSS ID in accordance with some embodiments. FIG. 8 illustrates a method 800 for BSS ID in accordance with some embodiments. FIGS. 7 and 8 are disclosed in conjunction with one another. FIG. 7 illustrates BSS1 752 and BSS2 754. HE station 104.1 and HE station 104.2 are associated with HE access point 102.1 and part of BSS1 752. HE station 104.3 is associated with HE access point 102.2 and part of BSS2 754.

Illustrated in FIG. 8 is time 802 along a horizontal axis, frequency 804 along a vertical axis, and transmitter/receiver 806 along a vertical axis. The methods 700 and 800 begin with a HE access point 102.1 transmitting a RTS 706. The methods 700 and 800 continue with HE station 104.1 transmitting CTS 708. HE station 104.2 at time 852 classifies CTS 708 as an intra BSS frame because the RA 308 (FIG. 3) of CTS 708 is the same as the BSSID 214.1 of HE access point 102.1, which HE station 104.2 is associated with. In accordance with some embodiments, at time 852, HE station 104.3 cannot classify the CTS 708 as an inter-BSS or intra-BSS frame, because the RA 308 of the CTS 708 does not match the BSSID 214.2 of HE access point 102.2 which HE station 104.3 is attached to.

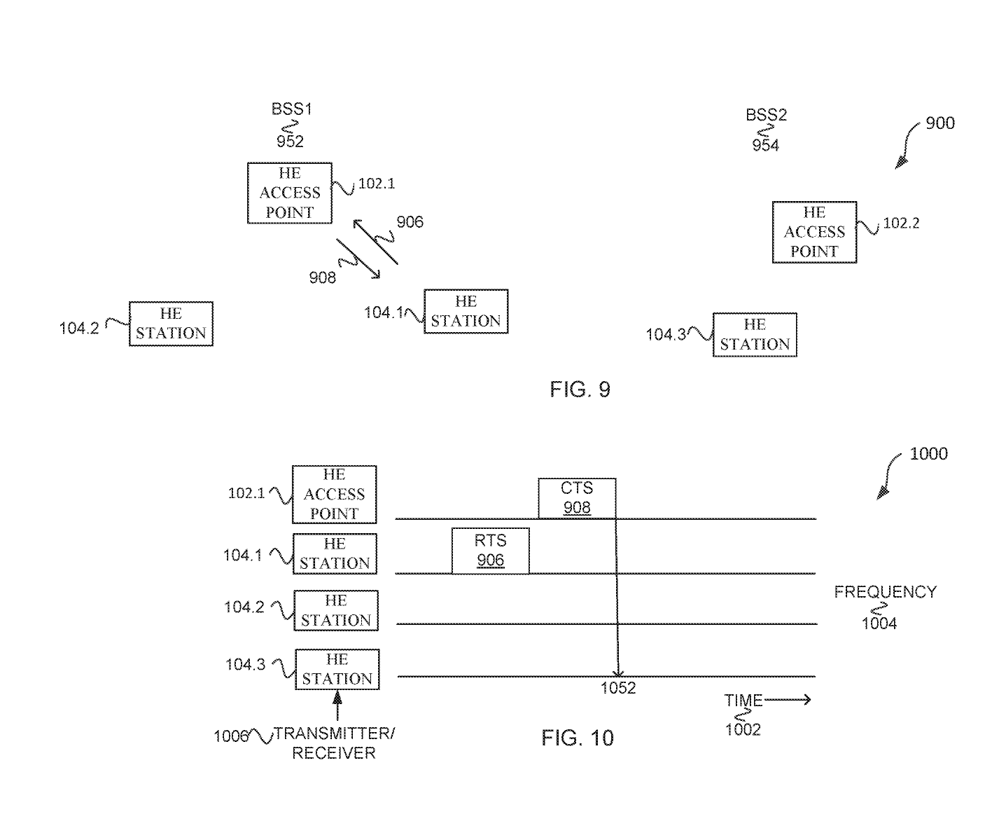

FIG. 9 illustrates a method 900 for BSS ID in accordance with some embodiments. FIG. 10 illustrates a method 1000 for BSS ID in accordance with some embodiments. FIGS. 9 and 10 are disclosed in conjunction with one another. FIG. 9 illustrates BSS1 952 and BSS2 954. HE station 104.1 and HE station 104.2 are associated with HE access point 102.1 and part of BSS1 952. HE station 104.3 is associated with HE access point 102.2 and part of BSS2 954.

Illustrated in FIG. 10 is time 1002 along a horizontal axis, frequency 1004 along a vertical axis, and transmitter/receiver 1006 along a vertical axis. The methods 900 and 1000 begin with a HE station 104.1 transmitting a RTS 906. The methods 900 and 1000 continue with HE access point 102.1 transmitting CTS 908. In accordance with some embodiments, HE station 104.2 at time 1052 classifies cannot classify CTS 908 as an intra-BSS frame or inter-BSS frame because the RA 308 (FIG. 3) of CTS 908 is of the HE station 104.1, which HE station 104.2 has not stored.

In accordance with some embodiments, at time 1052, HE station 104.3 cannot classify the CTS 908 as an inter-BSS or intra-BSS frame, because the RA 308 of the CTS 908 does not match the BSSID 214.2 of HE access point 102.2 which HE station 104.3 is attached to.

In some embodiments, when an HE station 104 receives a RTS frame 600, the HE station 104 may compare both the RA 608 field and the TA 610 field to determine if the RA 608 field or the TA 610 field matches a BSSID 214 of the HE access point 102 the HE station 104 is associated with, then the HE station 104 classifies the frame as an intra-BSS frame.

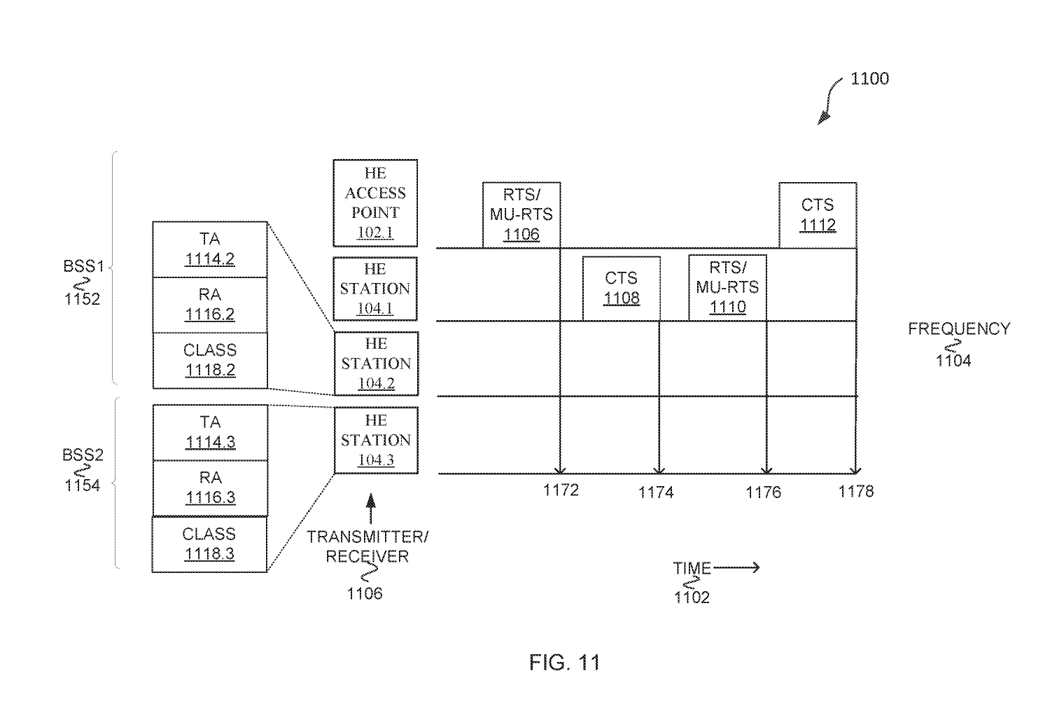

FIG. 11 illustrates a method 1100 for BSS ID in accordance with some embodiments. Illustrated in FIG. 11 is time 1102 along a horizontal axis, frequency 1104 along a vertical axis, transmitter/receiver 1106 along a vertical axis, and BSS along a vertical axis. HE access point 102.1, HE station 104.1, and HE station 104.2 are part of BSS1 1152. HE station 104.2 is part of BSS2 1154. HE stations 104 may include a TA 1114, RA 1116, and/or classification (class) 1118 for storing information about a communication 252. The TA 1114, RA 1116, and/or class 1118 may be used to classify a subsequent frame, or to classify the frame that the information was stored for at a later time.

The method 1100 begins with a HE access point 102.1 transmitting a RTS/MU-RTS 1106 to HE station 104.1. At time 1172, HE station 104.2 stores TA 610 (FIG. 6) of RTS/MU-RTS 1106 in TA 1114.2 or stores a nonbandwidth signaling TA 610 (FIG. 6) of RTS/MU-RTS 1106 in TA 1114.2. The nonbandwidth signaling TA 610 (FIG. 6) of RTS/MU-RTS 1106 may be indicated by a value of 0 of an individual/group field (not illustrated) of the RTS/MU-RTS 1106. A nonbandwidth signaling TA 610 indicates the TA is the TXOP holder address. If the group/multicast bit of TA 610 is set to 0, then it indicates the TA 1114 is the transmitter address (e.g., TXOP holder address), and the TA 610 may be termed a nonbandwidth signaling TA. If the group/multicast bit of TA 610 is set to 1, then it indicates the TA 1114 is termed a bandwidth signaling TA, which indicates that a bandwidth is indicated of the transmission. The HE station 104 and/or HE access point 102 may be configured to reset the group/multicast bit to zero when storing the TA 610 of RTS/MU-RTS 1105. This may enable a comparison with the RA 608 of the CTS 1108. The HE station 104 and/or HE access point 102 may be configured to store the TA 610 so that it will match the generated RA 308 (by the HE station 104 or HE access point 102) of the CTS 1108.

HE station 104.2 then stores RA 608 (FIG. 6) of RTS/MU-RTS 1106 in RA 1116.2. HE station 104.2 may classify the RTS/MU-RTS 1106 as an intra-BSS RTS/MU-RTS since the TA 610 of the RTS/MU-RTS 1106 matches the BSSID 214.1 of the HE access point 102.1. HE station 104.2 may store the classification in classification 1118.2.

And, at time 1172, HE station 104.3 stores TA 610 (FIG. 6) of RTS/MU-RTS 1106 in TA 1114.3 or stores the nonbandwidth signaling TA of 610 (FIG. 6) of RTS/MU-RTS 1106 in TA 1114.2. If TA 610 of RTS/MU-RTS 1106 is a nonbandwidth signaling TA 610, then the stored TA 1114.3 is the TXOP holder address. HE station 104.3 then stores RA 608 (FIG. 6) of RTS/MU-RTS 1106 in RA 1116.3.

HE station 104.3 may classify RTS/MU-RTS 1106 as an inter-BSS RTS/MU-RTS since neither the TA 610 of the RTS/MU-RTS 1106 nor the RA 608 of the RTS/MU-RTS 1106 match a BSSID 214.2 of a HE access point 102.2 that HE station 104.3 is associated with. In some embodiments, HE station 104.3 stores the classification of RTS/MU-RTS 1106 as an inter-BSS RTS/MU-RTS in classification 1118.3.

The method 1100 continues with HE station 104.1 transmitting CTS 1108 to HE access point 102 in response to the RTS/MU-RTS 1106. In some embodiments, at time 1174, HE station 104.2 classifies CTS 1108 as an intra-BSS frame because the RA 308 (FIG. 3) of CTS 1108 is the same as the BSSID 214.1 (FIG. 2) of HE access point 102.1, which HE station 104.2 is associated with. In some embodiments, at time 1174, HE station 104.2 classifies CTS 1108 as an intra-BSS frame because the RA 308 (FIG. 3) of CTS 1108 matches the stored TA 1114.2 address for the RTS/MU-RTS 1106, and the RTS/MU-RTS 1106 was classified as an intra-BSS RTS/MU-RTS.

At time 1174, HE station 104.3, classifies CTS 1108 as an inter-BSS frame because RA 308 (FIG. 3) of CTS 1108 matches TA 1114.3 that was stored for the RTS/MU-RTS 1106, and RTS/MU-RTS 1106 was classified as an inter-BSS RTS/MU-RTS, which may have been stored in classification 1118.3.

In some embodiments, the method 1100 continues with a HE station 104.1 transmitting a RTS/MU-RTS 1110. At time 1176, HE station 104.2 stores TA 610 (FIG. 6) of RTS/MU-RTS 1110 in TA 1114.2, and stores RA 608 (FIG. 6) of RTS/MU-RTS 1110 in RA 1116.2. HE station 104.2 may classify the RTS/MU-RTS 1110 as an intra-BSS RTS/MU-RTS since the RA 608 of the RTS/MU-RTS 1110 matches the BSSID 214.1 of the HE access point 102.1. HE station 104.2 may store the classification in classification 1118.2.

And, at time 1176, HE station 104.3 stores TA 610 (FIG. 6) of RTS/MU-RTS 1110 in TA 1114.3, and stores RA 608 (FIG. 6) of RTS/MU-RTS 1110 in RA 1116.3. HE station 104.3 may classify RTS/MU-RTS 1110 as an inter-BSS RTS/MU-RTS since neither the TA 610 of the RTS/MU-RTS 1110 nor the RA 608 of the RTS/MU-RTS 1110 match a BSSID 214.2 of a HE access point 102.2 that HE station 104.3 is associated with. In some embodiments, HE station 104.3 stores the classification of RTS/MU-RTS 1110 as an inter-BSS RTS/MU-RTS in classification 1118.3.

The method 1100 continues with HE access point 102.1 transmitting CTS 1112. In accordance with some embodiments, at time 1178, HE station 104.2 at time 1178 classifies CTS 1112 as an intra-BSS CTS because the RA 308 (FIG. 3) of CTS 1112 matches the TA 1114.2 of the RTS/MU-RTS 1110, and the RTS/MU-RTS 1110 was classified as an intra-BSS RTS/MU-RTS at time 1176.

In accordance with some embodiments, at time 1 178, HE station 104.3 classifies the CTS 1112 as an inter-BSS CTS, because the RA 308 of the CTS 1112 matches the TA 1114 stored for the RTS/MU-RTS 1110 and the RTS/MU-RTS 1110 was classified as an inter-BSS RTS/MU-RTS.

In some embodiments, the HE stations 104 will not respond to the RTS/MU-RTS 1106 if the RA 308 of the RTS/MU-RTS matches a MAC address of the HE station 104.

In some embodiments, the HE stations 104 may receive multiple CTSs 1108 on multiple frequencies or channels in response to the RTS/MU-RTS, and the HE stations 104 may use the same method to classify the multiple CTSs as the one CTS 1108 or CTS 1112 as described herein.

In some embodiments, if the HE station 104 only receives the CTS 1108 or CTS 1112 and not the RTS/MU-RTS 1106, then the HE station 104 may determine that the HE station 104 cannot perform spatial reuse as there may be a hidden HE station 104.

As illustrated, the times 1172, 1174, 1176, and 1178 are after the frames, but the HE stations 104 and/or HE access point 102 may decode the frames (RTS/MU-RTS 1106, CTS 1108, RTS/MU-RTS 1110, or CTS 1112) and begin method operations after partially decoding the frames.

In some embodiments, the HE stations 104 are configured to check to see if the RA 308 of the CTS 1108 or 1112 matches the BSSID (214.1 or 214.2) of their BSS (e.g., 206 or 208) to see if the CTS 1108 or 1112 is a inter-BSS or intra-BSS CTS, and if there is not a match, then the HE stations 104 are configured to check the stored information (e.g., TA 1114, RA 1116, class 1118) to determine whether the CTS 1108 or 1112 is an inter or intra-BSS CTS.

In some embodiments, the first RTS/MU-RTS 1106 and CTS 1108 are a first method and the second RTS/MU-RTS 1110 and CTS 1112 are a second method.

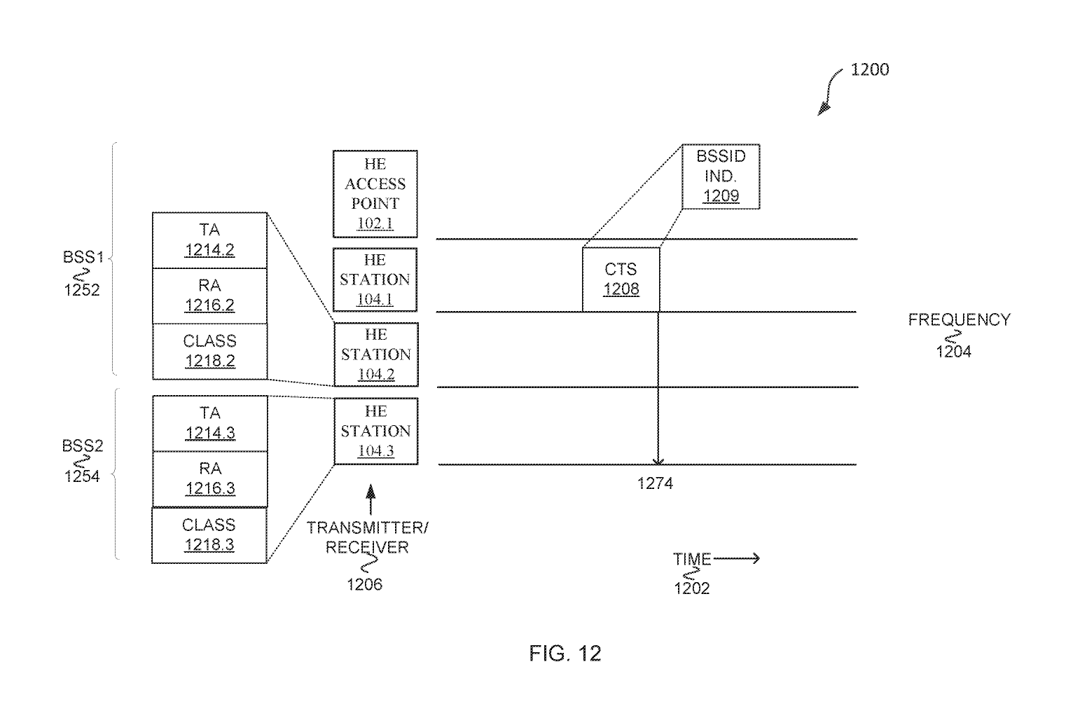

FIG. 12 illustrates a method 1200 for BSS ID in accordance with some embodiments. Illustrated in FIG. 12 is time 1202 along a horizontal axis, frequency 1204 along a vertical axis, transmitter/receiver 1206 along a vertical axis, and BSS along a vertical axis. HE access point 102.1, HE station 104.1, and HE station 104.2 are part of BSS1 1252. HE station 104.2 is part of BSS2 1254. HE stations 104 may include a TA 1214, RA 1216, and/or classification (class) 1218 for storing information about a communication 252. The TA 1214, RA 1216, and/or class 1218 may be used to classify a subsequent frame, or to classify the frame that the information was stored for at a later time.

The method 1200 begins with a HE access point 102.1 transmitting a CTS 1208. The CTS 1208 may be a CTS-to-self CTS. The CTS 1208 may include a BSSID indication 1209. If the BSSID indication 1209 is set, then the RA 308 (FIG. 3) of the CTS 1209 is a BSSID 214 of the HE access point 102 that the HE station 104 is associated with.

At time 1274, HE station 104.2 may compare the RA 308 (FIG. 3) of the CTS 1208 with a BSSID 214.1 of HE access point 102.1 and if they match, then HE station 104.2 determines that the CTS 1208 is an intra-BSS CTS. In some embodiments, if RA 308 (FIG. 3) of CTS 1208 does not match BSSID 214.1 of HE access point 102.1, then the HE station 104.2 determines that the CTS 1208 is an inter-BSS CTS.

At time 1274, HE station 104.3 may compare the RA 308 (FIG. 3) of the CTS 1208 with a BSSID 214.2 of HE access point 102.2 (see FIG. 2 where HE station 104.3 is attached to HE access point 102.2) and if they match, then HE station 104.3 determines that the CTS 1208 is an intra-BSS CTS. In some embodiments, if RA 308 (FIG. 3) of CTS 1208 does not match BSSID 214.2 of HE access point 102.2, then the HE station 104.3 determines that the CTS 1208 is an inter-BSS CTS.

In some embodiments, the HE station 104.2 and/or HE station 104.3 may receive and decode a RTS or MU-RTS prior to the CTS 1208. The HE station 104.2 and/or HE station 104.3 may store information (e.g., TA 1214, RA 1216, and/or class 1218) and use the stored information to assist in classifying the CTS 1208.

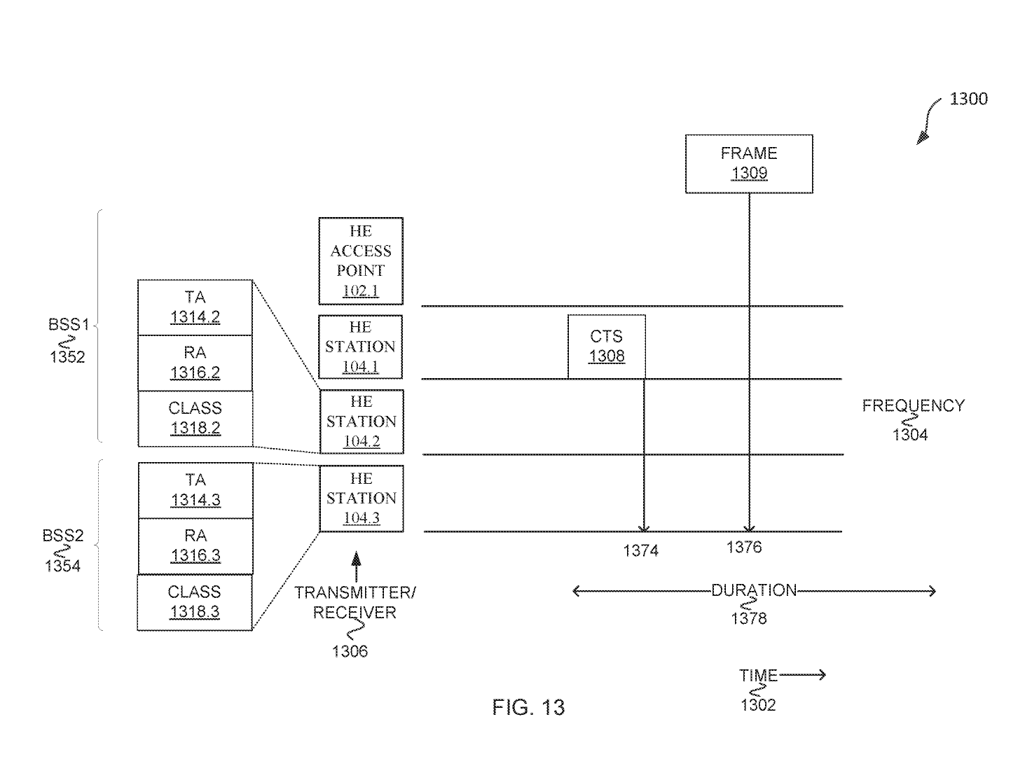

FIG. 13 illustrates a method 1300 for BSS ID in accordance with some embodiments. Illustrated in FIG. 13 is time 1302 along a horizontal axis, frequency 1304 along a vertical axis, transmitter/receiver 1306 along a vertical axis, and BSS along a vertical axis. HE access point 102.1, HE station 104.1, and HE station 104.2 are part of BSS1 1352. HE station 104.2 is part of BSS2 1354. HE stations 104 may include a TA 1314, RA 1316, and/or classification (class) 1318 for storing information about a communication 252. The TA 1314, RA 1316, and/or class 1318 may be used to classify a subsequent frame, or to classify the frame that the information was stored for at a later time.

The method 1300 begins with HE station 104.1 transmitting a CTS 1308, which is in response to a MU-RTS or RTS (not illustrated). At time 1374, HE station 104.3 receives the CTS 1308. HE station 104.3 missed the RTS or MU-RTS that the CTS 1308 is in response to, e.g., the RTS or MU-RTS may have had interference problems. The duration 1378 may be the duration 306 of the CTS 1308. The HE station 104.3 may store information about the CTS 1308 such as the RA 308 (FIG. 3) of the CTS 1308. The HE station 104.3 may update a NAV by the duration 1378 based on not being able to determine whether the CTS 1306 is an inter or intra BSS CTS.

The method 1300 continues at time 1376 with the HE station 104.3 receiving frame 1309. If the frame 1309 is received during the duration 1378, and the TA field of the frame 1309 matches the RA 308 (FIG. 3) of the CTS 1308, which may have been stored in RA 1316.3, then if frame 1309 is identified as an intra-BSS frame, then the CTS 1308 is identified as an intra-BSS CTS. And, if the frame 1309 is identified as an inter-BSS frame, then the CTS 1308 is identified as an inter-BSS CTS. In some embodiments, if a NAV is set by the CTS 1308 based on the duration 306 of the CTS 1308, then the NAV may be reset if the CTS 1308 is identified as an inter-BSS CTS. This may enable the HE station 104.3 to transmit before the remainder of the duration 1378. In some embodiments, the time 1376 may be when the HE station 104.3 decodes a MAC portion of the frame 1309.

FIG. 14 illustrates a method 1400 for BSS ID in accordance with some embodiments. Illustrated in FIG. 14 is time 1402 along a horizontal axis, frequency 1404 along a vertical axis, transmitter/receiver 1406 along a vertical axis, and BSS along a vertical axis. HE access point 102.1, HE station 104.1, and HE station 104.2 are part of BSS1 1452. HE station 104.2 is part of BSS2 1454. HE stations 104 may include a TA 1414, RA 1416, classification (class) 1418, and/or BSSID 1424 for storing information about a communication 252. The TA 1414, RA 1416, class 1418, and/or BSSID 1424 may be used to classify a subsequent frame, or to classify the frame that the information was stored for at a later time.

The method 1400 begins at time 1474 with HE station 104.3 receiving data frame 1409. HE station 104.3 may store information about the data frame 1409, e.g., a TA of the data frame 1409 in TA 1414.3, and a BSSID (e.g., 214) of the data frame 1409. The HE station 104.3 may not store the TA of the data frame 1409 if the RA of the data frame 1409 is equal to a MAC address of the HE station 104.3, if the RA of the data frame 1409 is a group address that requires the HE station 104.3 to decode the data frame 1409, or the RA of the data frame 1409 is a broadcast address that requires the HE station 104.3 to decode the data frame 1409.

The method 1400 continues at time 1476 with the HE stations 104.3 receiving the ACK 1408 frame. The HE station 104.3 determines if the RA 408 (FIG. 4) of the ACK 1408 frame matches the TA of the data frame. If there is a match, then the BSSID (e.g., the BSSID stored in BSSID 1424.3) is used as the BSSID of the ACK 1408 frame for determining if the ACK 1408 frame is an inter or intra BSS frame.

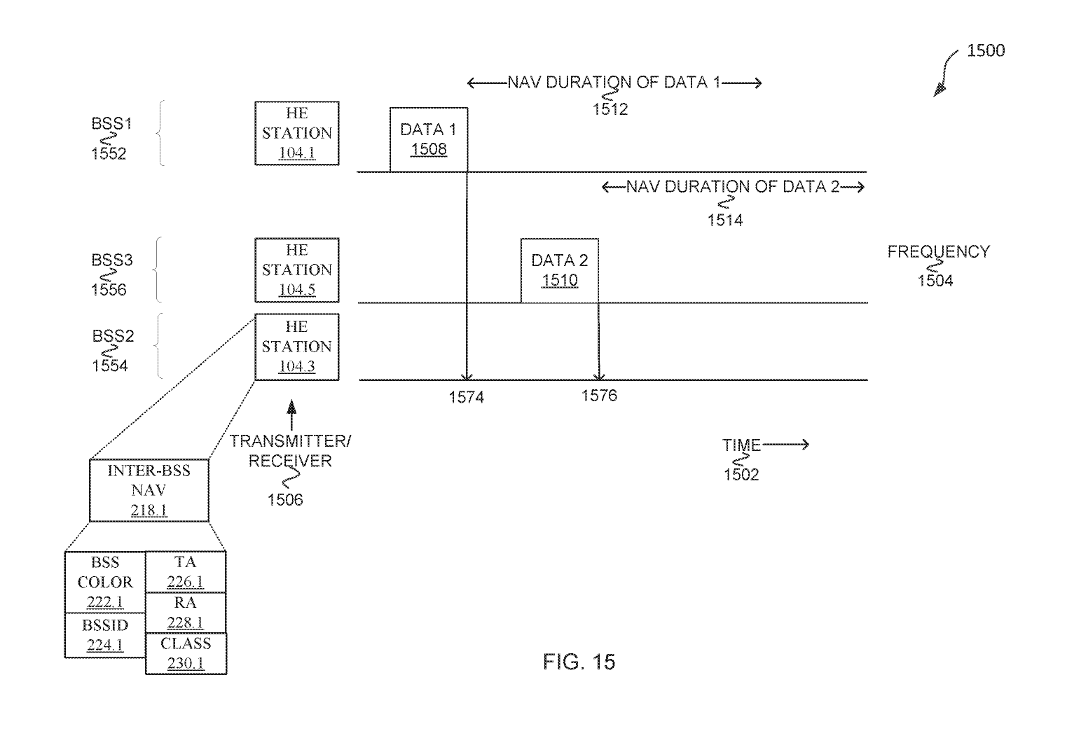

FIG. 15 illustrates a method 1500 for BSS ID in accordance with some embodiments. Illustrated in FIG. 15 is time 1502 along a horizontal axis, frequency 1504 along a vertical axis, transmitter/receiver 1506 along a vertical axis, and BSS along a vertical axis. HE station 104.1 is part of BSS1 1552. HE station 104.5 is part of BSS3 1556. HE station 104.3 is part of BSS2 1554. HE stations 104 may be HE stations 104 and/or HE access points 102.

HE stations 104 may include one or more NAVs, e.g., inter-BSS NAV 218.1 and intra-BSS NAV 218.2 (FIG. 2). There may be information associated with a NAV. For example, BSS color 222.1, BSSID 224.1, TA 226.1, RA 228.1, and/or class 230.1 may be associated with inter-BSS NAV 218.1.

HE stations 104 may be configured to record the BSSID 224.1 and/or the BSS color 222.1 associated with an inter-BSS NAV 218.1 when the inter-BSS NAV 218.1 is set. HE stations 104 may be configured to record the BSSID 224.2 and/or the BSS color 222.2 associated with an intra-BSS NAV 218.2 when the intra-BSS NAV 218.2 is set. For example, a value of a BSS color field of a HE signal field A (HE-SIG-A) of a HE PPDU may be recorded in the BSS color 222 field when a inter-BSS NAV 218.1 or an intra-BSS NAV 218.2 is set by a TXOP duration field in the HE-SIG-A.

In another example, BSSID is recorded in the BSSID 224 field when the inter-BSS NAV 218.1 or intra-BSS NAV 218.2 is set by the duration field in a MAC header, and the BSSID is located in the MAC header.

In some embodiments, a HE station 104 is configured to record an RA and TA address of a frame in the TA 226 and RA 228 fields, respectively, as the potential BSSID of the frame, when the HE station 104 set an inter-BSS NAV 218.1 or an intra-BSS NAV 218.2 by a duration field of the frame and there is no BSSID field for the frame.

In some embodiments, a HE station 104 is configured to record the RA 608 and TA 610 when a duration of the RTS frame 600 is used to set inter-BSS NAV 218.1 or intra-BSS NAV 218.2.

The method 1500 may begin at time 1574 with HE station 104.3 setting inter-BSS NAV 218.1 (to NAV duration of data 1 1512) by a NAV duration of data 1 1508 and records BSS 1 1552 as the BSSID 224.1.

The method 1500 may continue at time 1576 with HE station 104.3 replacing the value of inter-BSS NAV 218.1 (with NAV duration of DATA 2 1514) and replacing BSS1 1552 with BSS3 1556 as the value of BSSID 224.1.

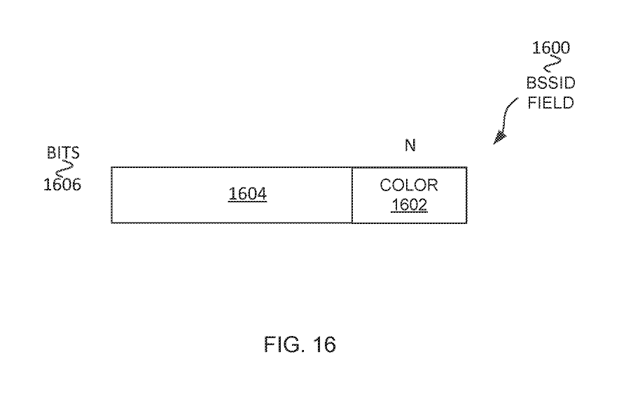

FIG. 16 illustrates a BSSID field 1600 in accordance with some embodiments. Illustrated in FIG. 16 is BSSID field 1600, color 1602, and remaining bits 1604. Bits 1606 may indicate a number of bits of the field. The color 1602 may be N bits 1606. This encoding enables a mapping between the BSSID 1600 and the color 1602. The color 1602 may be a separate field, e.g., in a HE-SIG-A field of a HE PPDU.

In some embodiments, a known hash function is used to convert the value of the BSSID 1600 field to the value of the color 1602. Color 1602 is only used for HE stations 104 and not legacy devices 106, so when a comparison is done if BSSID is from the same HE station 104, there will be no collusion. If a BSSID is from a different HE station 104, then the probably of a collision is low. In some embodiments, the HE access point 102 is configured to change a MAC address of the HE access point 102 so that the color 1602 may match the N bits 1606. In some embodiments, a management entity (not illustrated) may assign the color 1602 to the HE access point 102.

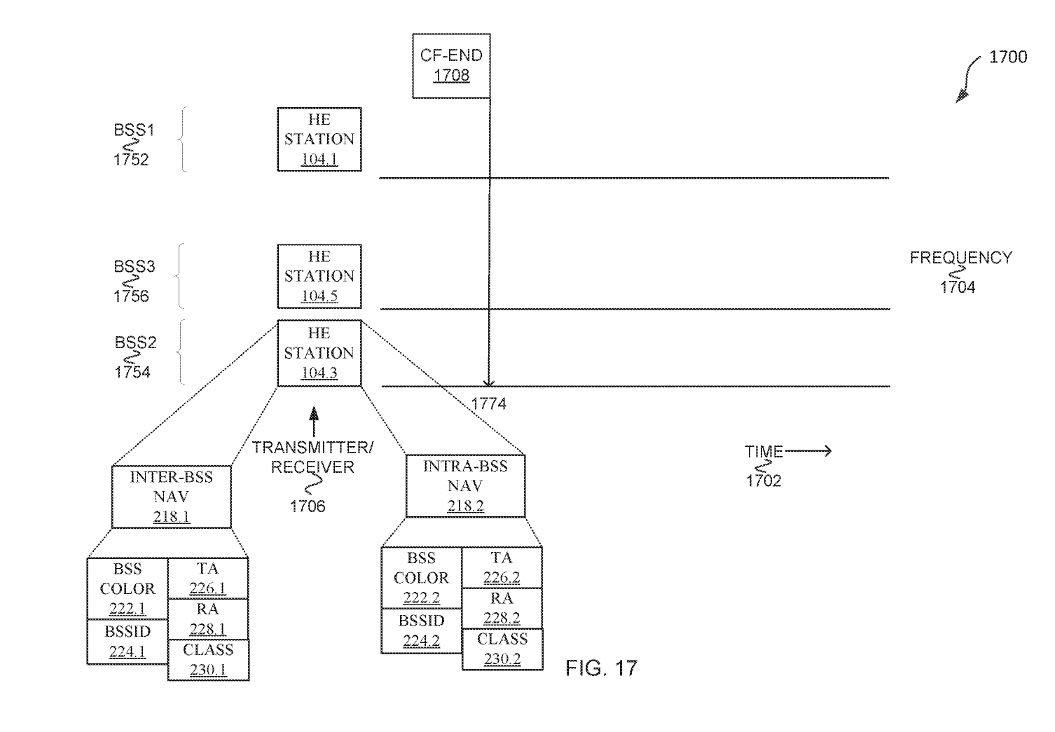

FIG. 17 illustrates a method 1700 for BSS ID in accordance with some embodiments. Illustrated in FIG. 17 is time 1702 along a horizontal axis, frequency 1704 along a vertical axis, transmitter/receiver 1706 along a vertical axis, and BSS along a vertical axis. HE station 104.1 is part of BSS1 1752. HE station 104.5 is part of BSS3 1756. HE station 104.3 is part of BSS2 1754. HE stations 104 may be HE stations 104 and/or HE access points 102.

HE stations 104 may include one or more NAVs, e.g., inter-BSS NAV 218.1 and intra-BSS NAV 218.2. There may be information associated with a NAV. For example, BSS color 222, BSSID 224, TA 226, RA 228, and/or class 230 may be associated with inter-BSS NAV 218.1 and intra-BSS NAV 218.2.

The method 1700 begins at time 1774 with HE station 104.3 decoding CF-end 1708. The CF-end 1708 may be from different BSSs, e.g., BSS2 1754, BSS3 1756, or BSS1 1752.

The HE station 104.3 may be configured to cancel inter-BSS NAV 218.1 or intra-BSS NAV 218.2 only if the BSSID of the CF-end 1708 matches a recorded BSSID 224 (which were recorded for the frame that set the inter-BSS NAV 218.1 or the intra-BSS NAV 218.2.)

The HE station 104.3 may be configured to cancel inter-BSS NAV 218.1 or intra-BSS NAV 218.2 only if the BSSID of the CF-end 1708 matches one of TA 226 or RA 228 (which were recorded for the frame that set the inter-BSS NAV 218.1 or the intra-BSS NAV 218.2.)

The HE station 104.3 may be configured to cancel inter-BSS NAV 218.1 or intra-BSS NAV 218.2 only if the BSSID of the CF-end 1708 can be linked to the BSS color 222 (which was recorded for the frame that set the inter-BSS NAV 218.1 or the intra-BSS NAV 218.2) by a hashing function or by a subset of the bits of the BSSID of the CF-end 1708 as disclosed in conjunction with FIG. 16.

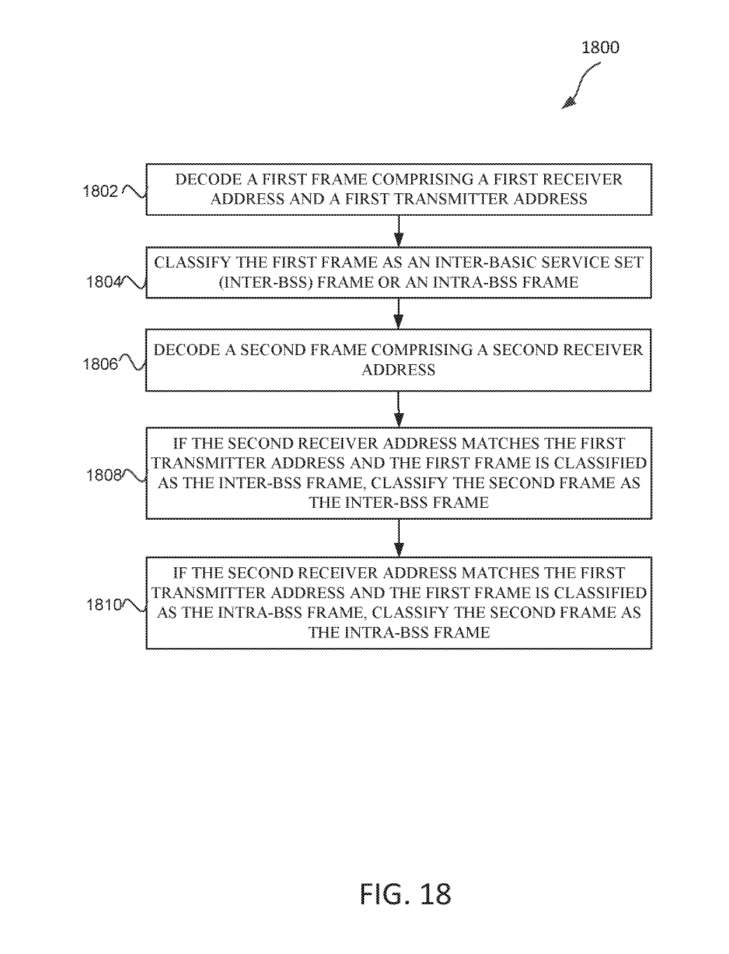

FIG. 18 illustrates a method 1800 for BSS ID in accordance with some embodiments. The method 1800 begins at operation 1802 with decoding a first frame comprising a first receiver address and a first transmitter address. For example, HE station 104.3 may decode data 1 1508 as described in conjunction with FIG. 15; HE station 104.3 may decode data frame 1409 as described in conjunction with FIG. 14; HE station 104.3 may decode CTS 1308 as described in conjunction with FIG. 13; and/or, HE station 104.3 may decode RTS/MU-RTS 1106, or RTS/MU-RTS 1110 as described in conjunction with FIG. 11.

The method may continue at operation 1804 with classifying the first frame as an inter-basic service set (inter-BSS) frame or an intra-BSS frame. For example, HE station 104.3 may classify data 1 1508 as described in conjunction with FIG. 15; HE station 104.3 may classify data frame 1409 as described in conjunction with FIG. 14; HE station 104.3 may classify CTS 1308 as described in conjunction with FIG. 13; and/or, HE station 104.3 may classify RTS/MU-RTS 1106, or RTS/MU-RTS 1110 as described in conjunction with FIG. 11.

The method may continue at operation 1806 with decoding a second frame comprising a second receiver address. For example, HE station 104.3 may decode data 2 1510 as described in conjunction with FIG. 15; HE station 104.3 may decode ACK 1408 as described in conjunction with FIG. 14; HE station 104.3 may decode frame 1309 as described in conjunction with FIG. 13; and/or, HE station 104.3 may decode CTS 1108, or CTS 1112 as described in conjunction with FIG. 11.

The method 1800 may continue at operation 1808 with if the second receiver address matches the first transmitter address and the first frame is classified as the inter-BSS frame, classifying the second frame as the inter-BSS frame. For example, HE station 104.3 may classify data 2 1510 as an inter-BSS frame as described in conjunction with FIG. 15; HE station 104.3 may classify ACK 1408 as an inter-BSS frame as described in conjunction with FIG. 14; HE station 104.3 may classify frame 1309 as an inter-BSS frame as described in conjunction with FIG. 13; and/or, HE station 104.3 may classify CTS 1108, or CTS 1112 as an inter-BSS frame as described in conjunction with FIG. 11.

The method 1800 may continue at operation 1810 with if the second receiver address matches the first transmitter address and the first frame is classified as the intra-BSS frame, classifying the second frame as the intra-BSS frame. For example, HE station 104.3 may classify data 2 1510 as an intra-BSS frame as described in conjunction with FIG. 15; HE station 104.3 may classify ACK 1408 as an intra-BSS frame as described in conjunction with FIG. 14; HE station 104.3 may classify frame 1309 as an intra-BSS frame as described in conjunction with FIG. 13; and/or, HE station 104.3 may classify CTS 1108, or CTS 1112 as an intra-BSS frame as described in conjunction with FIG. 11.

One or more of the operation of method 1800 may be performed by an apparatus of a HE station 104 and/or of a HE access point 102.

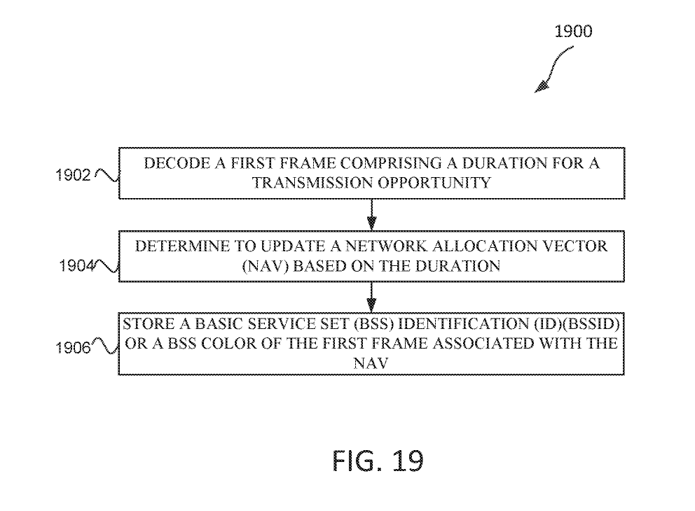

FIG. 19 illustrates a method 1900 for BSS ID in accordance with some embodiments. The method 1900 may begin at operation 1902 with decoding a first frame comprising a duration for a transmission opportunity. For example, HE station 104.3 may decode data 1 1508.

The method 1900 continues at operation 1904 with determining to update a network allocation vector (NAV) based on the duration. For example, HE station 104.2 may determine to update inter-BSS NAV 218.1 based on NAV duration of data 1 1512.

The method 1900 continues at operation 1906 with storing a BSSID or a BSS color of the first frame associated with the NAV. For example, HE station 104.3 may store a BSS color or BSSID of data 1 1508 in BSS color 222.1 or BSSID 224.1.

One or more of the operation of method 1900 may be performed by an apparatus of a HE station 104 and/or of a HE access point 102.

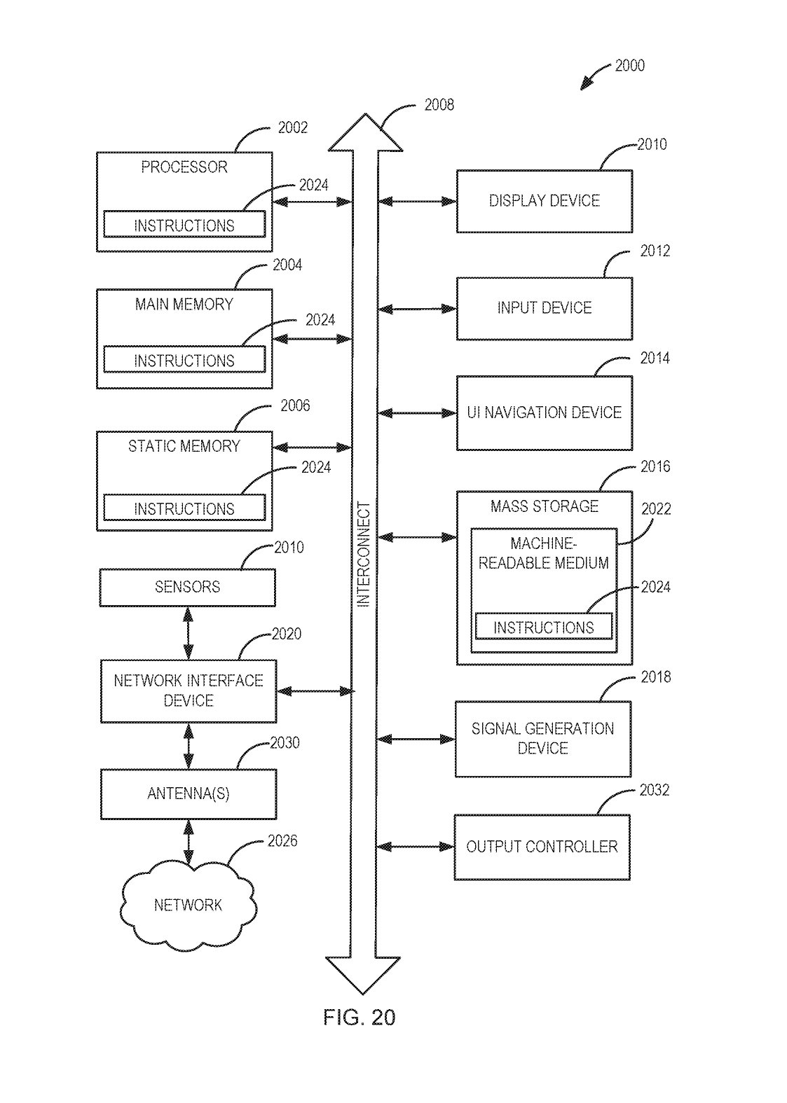

FIG. 20 illustrates a block diagram of an example machine 2000 upon which any one or more of the techniques (e.g., methodologies) discussed herein may perform. In alternative embodiments, the machine 2000 may operate as a standalone device or may be connected (e.g., networked) to other machines. In a networked deployment, the machine 2000 may operate in the capacity of a server machine, a client machine, or both in server-client network environments. In an example, the machine 2000 may act as a peer machine in peer-to-peer (P2P) (or other distributed) network environment. The machine 2000 may be a HE access point 102, HE station 104, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 2000 may include a hardware processor 2002 (e.g., a central processing unit (CPU), a graphics processing unit (GPU), a hardware processor core, or any combination thereof), a main memory 2004 and a static memory 2006, some or all of which may communicate with each other via an interlink (e.g., bus) 2008.

Specific examples of main memory 2004 include Random Access Memory (RAM), and semiconductor memory devices, which may include, in some embodiments, storage locations in semiconductors such as registers. Specific examples of static memory 2006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 2000 may further include a display device 2010, an input device 2012 (e.g., a keyboard), and a user interface (UI) navigation device 2014 (e.g., a mouse). In an example, the display device 2010, input device 2012 and UI navigation device 2014 may be a touch screen display. The machine 2000 may additionally include a mass storage (e.g., drive unit) 2016, a signal generation device 2018 (e.g., a speaker), a network interface device 2020, and one or more sensors 2021, such as a global positioning system (GPS) sensor, compass, accelerometer, or other sensor. The machine 2000 may include an output controller 2028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 2002 and/or instructions 2024 may comprise processing circuitry and/or transceiver circuitry.

The storage device 2016 may include a machine readable medium 2022 on which is stored one or more sets of data structures or instructions 2024 (e.g., software) embodying or utilized by any one or more of the techniques or functions described herein. The instructions 2024 may also reside, completely or at least partially, within the main memory 2004, within static memory 2006, or within the hardware processor 2002 during execution thereof by the machine 2000. In an example, one or any combination of the hardware processor 2002, the main memory 2004, the static memory 2006, or the storage device 2016 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 2022 is illustrated as a single medium, the term “machine readable medium” may include a single medium or multiple media (e.g., a centralized or distributed database, and/or associated caches and servers) configured to store the one or more instructions 2024.

An apparatus of the machine 2000 may be one or more of a hardware processor 2002 (e.g., a central processing unit (CPU), a graphics processing unit (GPU), a hardware processor core, or any combination thereof), a main memory 2004 and a static memory 2006, sensors 2021, network interface device 2020, antennas 2060, a display device 2010, an input device 2012, a UI navigation device 2014, a mass storage 2016, instructions 2024, a signal generation device 2018, and an output controller 2028. The apparatus may be configured to perform one or more of the methods and/or operations disclosed herein. The apparatus may be intended as a component of the machine 2000 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 2000 and that cause the machine 2000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 2024 may further be transmitted or received over a communications network 2026 using a transmission medium via the network interface device 2020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 2020 may include one or more physical jacks (e.g., Ethernet, coaxial, or phone jacks) or one or more antennas to connect to the communications network 2026. In an example, the network interface device 2020 may include one or more antennas 2060 to wirelessly communicate using at least one of single-input multiple-output (SIMO), multiple-input multiple-output (MIMO), or multiple-input single-output (MISO) techniques. In some examples, the network interface device 2020 may wirelessly communicate using Multiple User MIMO techniques. The term “transmission medium” shall be taken to include any intangible medium that is capable of storing, encoding or carrying instructions for execution by the machine 2000, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

The following examples pertain to further embodiments. Example 1 is an apparatus of a station including: a memory; and processing circuitry coupled to the memory, where the processing circuitry is configured to: decode a first frame including a first receiver address and a first transmitter address; classify the first frame as an inter-basic service set (inter-BSS) frame or an intra-BSS frame; decode a second frame including a second receiver address; if the second receiver address matches the first transmitter address and the first frame is classified as the inter-BSS frame, classify the second frame as the inter-BSS frame; and if the second receiver address matches the first transmitter address and the first frame is classified as the intra-BSS frame, classify the second frame as the intra-BSS frame.

In Example 2, the subject matter of Example 1 optionally includes where the first frame is a request-to-send or a high-efficiency multi-user request-to-send and the second frame is a clear-to-send.

In Example 3, the subject matter of any one or more of Examples 1-2 optionally include where the first frame is a data frame and the second frame is an acknowledgement (ACK) frame.

In Example 4, the subject matter of any one or more of Examples 1-3 optionally include where the first transmitter address is a transmission opportunity holder address.

In Example 5, the subject matter of any one or more of Examples 1-4 optionally include where the first frame further comprises a duration field, the duration field indicating a duration for a transmission opportunity, and where the second frame is received during the transmission opportunity.

In Example 6, the subject matter of any one or more of Examples 1-5 optionally include where the first frame further comprises a duration field, the duration field indicating a duration for a transmission opportunity, and where the processing circuitry is further configured to: if the second frame is received during the transmission opportunity, and if the second receiver address matches the first transmitter address, classify the second frame as the inter-BSS frame if the first frame is classified as the inter-BSS frame, and classify the second frame as the intra-BSS frame if the first frame is classified as the intra-BSS frame.

In Example 7, the subject matter of any one or more of Examples 1-6 optionally include where the processing circuitry is further configured to: classify the first frame as the intra-BSS frame if the first transmitter address matches a media access control (MAC) address of an access point that the station is associated with.

In Example 8, the subject matter of any one or more of Examples 1-7 optionally include where the processing circuitry is further configured to: if the second frame is classified as the inter-BSS frame, determine whether spatial reuse can be used, and if spatial reuse can be used, encode a third frame with a third receiver address, and configure the station to transmit the third frame.

In Example 9, the subject matter of any one or more of Examples 1-8 optionally include where the processing circuitry is further configured to: classify the first frame as the intra-BSS frame if the first receiver address matches a media access control (MAC) address of an access point the station is associated with.

In Example 10, the subject matter of any one or more of Examples 1-9 optionally include where the processing circuitry is further configured to: configure the station to receive the first frame and the second frame in accordance with one or both of the following group: orthogonal frequency division multiple access (OFDMA) and multi-user multiple-input multiple-output (MU-MIMO).

In Example 11, the subject matter of any one or more of Examples 1-10 optionally include where the first frame and the second frame are physical (PHY) layer convergence procedure (PLCP) protocol data units (PPDUs).

In Example 12, the subject matter of any one or more of Examples 1-11 optionally include where the first frame further comprises a first BSS color, and where the processing circuitry is further configured to: classify the first frame as the intra-BSS frame if the first BSS color matches a second BSS color of an access point the station is associated with.

In Example 13, the subject matter of Example 12 optionally includes where the first frame is a high efficiency (HE) frame.

In Example 14, the subject matter of any one or more of Examples 1-13 optionally include ax station.

In Example 15, the subject matter of any one or more of Examples 1-14 optionally include transceiver circuitry coupled to the memory; and, one or more antennas coupled to the transceiver circuitry.

Example 16 is a non-transitory computer-readable storage medium that stores instructions for execution by one or more processors, the instructions to configure the one or more processors to cause an apparatus of a station to: decode a first frame including a first receiver address and a first transmitter address; classify the first frame as an inter-basic service set (inter-BSS) frame or an intra-BSS frame; decode a second frame including a second receiver address; if the second receiver address matches the first transmitter address and the first frame is classified as the inter-BSS frame, classify the second frame as the inter-BSS frame; and if the second receiver address matches the first transmitter address and the first frame is classified as the intra-BSS frame, classify the second frame as the intra-BSS frame.

In Example 17, the subject matter of any one or more of Examples 15-16 optionally include where the first frame is a request-to-send or a multi-user request-to-send and the second frame is a clear-to-send, or the first frame is a data frame and the second frame is an acknowledgement (ACK) frame.

In Example 18, the subject matter of any one or more of Examples 15-17 optionally include where the first frame further comprises a duration field, the duration field indicating a duration for a transmission opportunity, and where the second frame is received during the transmission opportunity.

Example 19 is a method performed by an apparatus of an access point, the method including: decoding a first frame including a first receiver address and a first transmitter address; classifying the first frame as an inter-basic service set (inter-BSS) frame or an intra-BSS frame; decoding a second frame including a second receiver address; classifying the second frame as the inter-BSS frame, if the second receiver address matches the first transmitter address and the first frame is classified as the inter-BSS frame; and classifying the second frame as the intra-BSS frame, if the second receiver address matches the first transmitter address and the first frame is classified as the intra-BSS frame.

In Example 20, the subject matter of Example 19 optionally includes where the first frame is a request-to-send or a high-efficiency multi-user request-to-send and the second frame is a clear-to-send, and where the method further comprises: classifying the first frame as the intra-BSS frame if the first transmitter address matches a media access control (MAC) address of an access point the station is associated with.

Example 21 is an apparatus of a station including: a memory; and processing circuitry coupled to the memory, where the processing circuitry is configured to: decode a first frame including a duration for a transmission opportunity; determine to update a network allocation vector (NAV) based on the duration; and store a basic service set (BSS) identification (ID)(BSSID) or a BSS color of the first frame associated with the NAV.

In Example 22, the subject matter of Example 21 optionally includes where the processing circuitry is further configured to: decode a second frame including a second duration for a second transmission opportunity, and further including a second BSSID or a second BSS color; determine to update the NAV based on the second duration; and store the second BSSID or the second BSS color of the second frame associated with NAV.

In Example 23, the subject matter of any one or more of Examples 21-22 optionally include where the processing circuitry is further configured to: determine whether the first frame is an intra-BSS frame or an inter-BSS frame; determine to update an inter-BSS NAV or an intra-BSS NAV based on the duration and whether the first frame is the intra-BSS frame of the inter-BSS frame; store the BSSID or the BSS color associated with the inter-BSS NAV, if it is determined to update the inter-BSS NAV; and store the BSSID and the BSS color associated with the intra-BSS NAV, if it is determined to update the intra-BSS NAV.

In Example 24, the subject matter of any one or more of Examples 21-23 optionally include where the processing circuitry is further configured to: if the first frame does not include the BSSID or the BSS color, then store a receiver address of the first frame and a transmitter address of the first frame associated with the NAV.

In Example 25, the subject matter of any one or more of Examples 21-24 optionally include transceiver circuitry coupled to the memory; and, one or more antennas coupled to the transceiver circuitry.

Example 26 is an apparatus of a station including: the apparatus including: means for decoding a first frame including a first receiver address and a first transmitter address; means for classifying the first frame as an inter-basic service set (inter-BSS) frame or an intra-BSS frame; means for decoding a second frame including a second receiver address; if the second receiver address matches the first transmitter address and the first frame is classified as the inter-BSS frame, means for classifying the second frame as the inter-BSS frame; and if the second receiver address matches the first transmitter address and the first frame is classified as the intra-BSS frame, means for classifying the second frame as the intra-BSS frame.

In Example 27, the subject matter of Example 26 optionally includes where the first frame is a request-to-send or a high-efficiency multi-user request-to-send and the second frame is a clear-to-send.

In Example 28, the subject matter of any one or more of Examples 26-27 optionally include where the first frame is a data frame and the second frame is an acknowledgement (ACK) frame.

In Example 29, the subject matter of any one or more of Examples 26-28 optionally include where the first transmitter address is a transmission opportunity holder address.

In Example 30, the subject matter of any one or more of Examples 26-29 optionally include where the first frame further comprises a duration field, the duration field indicating a duration for a transmission opportunity, and where the second frame is received during the transmission opportunity.

In Example 31, the subject matter of any one or more of Examples 27-30 optionally include where the first frame further comprises a duration field, the duration field indicating a duration for a transmission opportunity, and where the apparatus further comprises: if the second frame is received during the transmission opportunity, and if the second receiver address matches the first transmitter address, means for classifying the second frame as the inter-BSS frame if the first frame is classified as the inter-BSS frame, and means for classifying the second frame as the intra-BSS frame if the first frame is classified as the intra-BSS frame.

In Example 32, the subject matter of any one or more of Examples 27-31 optionally include where the apparatus further including: means for classifying the first frame as the intra-BSS frame if the first transmitter address matches a media access control (MAC) address of an access point that the station is associated with.

In Example 33, the subject matter of any one or more of Examples 27-32 optionally include where the apparatus further comprises: if the second frame is classified as the inter-BSS frame, means for determining whether spatial reuse can be used, and if spatial reuse can be used, means for encoding a third frame with a third receiver address, and configure the station to transmit the third frame.

In Example 34, the subject matter of any one or more of Examples 27-33 optionally include where the apparatus further comprises: means for classifying the first frame as the intra-BSS frame if the first receiver address matches a media access control (MAC) address of an access point the station is associated with.

In Example 35, the subject matter of any one or more of Examples 27-34 optionally include where the apparatus further comprises: means for configuring the station to receive the first frame and the second frame in accordance with one or both of the following group: orthogonal frequency division multiple access (OFDMA) and multi-user multiple-input multiple-output (MU-MIMO).

In Example 36, the subject matter of any one or more of Examples 27-35 optionally include where the first frame and the second frame are physical (PHY) layer convergence procedure (PLCP) protocol data units (PPDUs).

In Example 37, the subject matter of any one or more of Examples 27-36 optionally include where the first frame further comprises a first BSS color, and where the apparatus further comprises: means for classifying the first frame as the intra-BSS frame if the first BSS color matches a second BSS color of an access point the station is associated with.

In Example 38, the subject matter of Example 37 optionally includes where the first frame is a high efficiency (HE) frame.

In Example 39, the subject matter of any one or more of Examples 27-38 optionally include ax station.

In Example 40, the subject matter of any one or more of Examples 27-39 optionally include means for processing radio frequency signals coupled to means for storing and retrieving data; and, means for transmitting and receiving the radio frequency signals.

Example 41 is a non-transitory computer-readable storage medium that stores instructions for execution by one or more processors, the instructions to configure the one or more processors to cause an apparatus of a station to: decode a first frame including a duration for a transmission opportunity; determine to update a network allocation vector (NAV) based on the duration; and store a basic service set (BSS) identification (ID)(BSSID) or a BSS color of the first frame associated with the NAV.

In Example 42, the subject matter of Example 41 optionally includes where the instructions further configure the one or more processors to cause the apparatus of the station to: decode a second frame including a second duration for a second transmission opportunity, and further including a second BSSID or a second BSS color; determine to update the NAV based on the second duration; and store the second BSSID or the second BSS color of the second frame associated with NAV.

In Example 43, the subject matter of any one or more of Examples 41-42 optionally include where the instructions further configure the one or more processors to cause the apparatus of the station to: determine whether the first frame is an intra-BSS frame or an inter-BSS frame; determine to update an inter-BSS NAV or an intra-BSS NAV based on the duration and whether the first frame is the intra-BSS frame of the inter-BSS frame; store the BSSID or the BSS color associated with the inter-BSS NAV, if it is determined to update the inter-BSS NAV; and store the BSSID and the BSS color associated with the intra-BSS NAV, if it is determined to update the intra-BSS NAV.

In Example 44, the subject matter of any one or more of Examples 41-43 optionally include where the instructions further configure the one or more processors to cause the apparatus of the station to: if the first frame does not include the BSSID or the BSS color, then store a receiver address of the first frame and a transmitter address of the first frame associated with the NAV.

Example 45 is a method performed by an apparatus of a station, method including: decoding a first frame including a duration for a transmission opportunity; determining to update a network allocation vector (NAV) based on the duration; and storing a basic service set (BSS) identification (ID)(BSSID) or a BSS color of the first frame associated with the NAV.

In Example 46, the subject matter of Example 45 optionally includes the method including: decode a second frame including a second duration for a second transmission opportunity, and further including a second BSSID or a second BSS color; determine to update the NAV based on the second duration; and store the second BSSID or the second BSS color of the second frame associated with NAV.

In Example 47, the subject matter of any one or more of Examples 45-46 optionally include the method including: determining whether the first frame is an intra-BSS frame or an inter-BSS frame; determining to update an inter-BSS NAV or an intra-BSS NAV based on the duration and whether the first frame is the intra-BSS frame of the inter-BSS frame; storing the BSSID or the BSS color associated with the inter-BSS NAV, if it is determined to update the inter-BSS NAV; and storing the BSSID and the BSS color associated with the intra-BSS NAV, if it is determined to update the intra-BSS NAV.

In Example 48, the subject matter of any one or more of Examples 45-47 optionally include the method including: if the first frame does not include the BSSID or the BSS color, then storing a receiver address of the first frame and a transmitter address of the first frame associated with the NAV.

Example 49 is an apparatus of a station, the apparatus including: means for decoding a first frame including a duration for a transmission opportunity; means for determining to update a network allocation vector (NAV) based on the duration; and means for storing a basic service set (BSS) identification (ID)(BSSID) or a BSS color of the first frame associated with the NAV.

In Example 50, the subject matter of Example 49 optionally includes the apparatus further including: means for decoding a second frame including a second duration for a second transmission opportunity, and further including a second BSSID or a second BSS color; means for determining to update the NAV based on the second duration; and means for storing the second BSSID or the second BSS color of the second frame associated with NAV.

In Example 51, the subject matter of any one or more of Examples 49-50 optionally include the apparatus further including: means for determining whether the first frame is an intra-BSS frame or an inter-BSS frame; means for determining to update an inter-BSS NAV or an intra-BSS NAV based on the duration and whether the first frame is the intra-BSS frame of the inter-BSS frame; means for storing the BSSID or the BSS color associated with the inter-BSS NAV, if it is determined to update the inter-BSS NAV; and means for storing the BSSID and the BSS color associated with the intra-BSS NAV, if it is determined to update the intra-BSS NAV.

In Example 52, the subject matter of any one or more of Examples 49-51 optionally include the apparatus further including: if the first frame does not include the BSSID or the BSS color, then means for storing a receiver address of the first frame and a transmitter address of the first frame associated with the NAV.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a station comprising: a memory; and processing circuitry coupled to the memory, wherein the processing circuitry is configured to:
decode a first frame comprising a first receiver address and a first transmitter address;
classify the first frame as an inter-basic service set (inter-BSS) frame or an intra-BSS frame;
decode a second frame comprising a second receiver address;
if the second receiver address matches the first transmitter address and the first frame is classified as the inter-BSS frame, classify the second frame as the inter-BSS frame; and
if the second receiver address matches the first transmitter address and the first frame is classified as the intra-BSS frame, classify the second frame as the intra-BSS frame.

2. The apparatus of claim 1, wherein the first frame is a request-to-send or a high-efficiency multi-user request-to-send and the second frame is a clear-to-send.

3. The apparatus of claim 1, wherein the first frame is a data frame and the second frame is an acknowledgement (ACK) frame.

4. The apparatus of claim 1, wherein the first transmitter address is a transmission opportunity holder address.

5. The apparatus of claim 1, wherein the first frame further comprises a duration field, the duration field indicating a duration for a transmission opportunity, and wherein the second frame is received during the transmission opportunity.

6. The apparatus of claim 1, wherein the first frame further comprises a duration field, the duration field indicating a duration for a transmission opportunity, and wherein the processing circuitry is further configured to:
if the second frame is received during the transmission opportunity, and if the second receiver address matches the first transmitter address, classify the second frame as the inter-BSS frame if the first frame is classified as the inter-BSS frame, and classify the second frame as the intra-BSS frame if the first frame is classified as the intra-BSS frame.

7. The apparatus of claim 1, wherein the processing circuitry is further configured to:
classify the first frame as the intra-BSS frame if the first transmitter address matches a media access control (MAC) address of an access point that the station is associated with.

8. The apparatus of claim 1, wherein the processing circuitry is further configured to:
if the second frame is classified as the inter-BSS frame, determine whether spatial reuse can be used, and if spatial reuse can be used, encode a third frame with a third receiver address, and configure the station to transmit the third frame.

9. The apparatus of claim 1, wherein the processing circuitry is further configured to:
classify the first frame as the intra-BSS frame if the first receiver address matches a media access control (MAC) address of an access point the station is associated with.

10. The apparatus of claim 1, wherein the processing circuitry is further configured to:
configure the station to receive the first frame and the second frame in accordance with one or both of the following group: orthogonal frequency division multiple access (OFDMA) and multi-user multiple-input multiple-output (MU-MIMO).

11. The apparatus of claim 1, wherein the first frame and the second frame are physical (PHY) layer convergence procedure (PLCP) protocol data units (PPDUs).

12. The apparatus of claim 1, wherein the first frame further comprises a first BSS color, and wherein the processing circuitry is further configured to:
classify the first frame as the intra-BSS frame if the first BSS color matches a second BSS color of an access point the station is associated with.

13. The apparatus of claim 12, wherein the first frame is a high efficiency (HE) frame.

14. The apparatus of claim 1, wherein the station is one or more from the following group: an Institute of Electrical and Electronic Engineers (IEEE) 802.11ax access point, an IEEE 802.11 station, an IEEE access point, a station acting as a group owner (GO), IEEE 802.11az station, IEEE 802.11az access point, and an IEEE 802.11ax station.

15. The apparatus of claim 1, further comprising transceiver circuitry coupled to the memory; and, one or more antennas coupled to the transceiver circuitry.

16. A non-transitory computer-readable storage medium that stores instructions for execution by one or more processors, the instructions to configure the one or more processors to cause an apparatus of a station to:
decode a first frame comprising a first receiver address and a first transmitter address;
classify the first frame as an inter-basic service set (inter-BSS) frame or an intra-BSS frame;
decode a second frame comprising a second receiver address;
if the second receiver address matches the first transmitter address and the first frame is classified as the inter-BSS frame, classify the second frame as the inter-BSS frame; and
if the second receiver address matches the first transmitter address and the first frame is classified as the intra-BSS frame, classify the second frame as the intra-BSS frame.

17. The non-transitory computer-readable storage medium of claim 15, wherein the first frame is a request-to-send or a multi-user request-to-send and the second frame is a clear-to-send, or the first frame is a data frame and the second frame is an acknowledgement (ACK) frame.

18. The non-transitory computer-readable storage medium of claim 15, wherein the first frame further comprises a duration field, the duration field indicating a duration for a transmission opportunity, and wherein the second frame is received during the transmission opportunity.

19. A method performed by an apparatus of an access point, the method comprising:
decoding a first frame comprising a first receiver address and a first transmitter address;
classifying the first frame as an inter-basic service set (inter-BSS) frame or an intra-BSS frame;
decoding a second frame comprising a second receiver address;
classifying the second frame as the inter-BSS frame, if the second receiver address matches the first transmitter address and the first frame is classified as the inter-BSS frame; and
classifying the second frame as the intra-BSS frame, if the second receiver address matches the first transmitter address and the first frame is classified as the intra-BSS frame.

20. The method of claim 19, wherein the first frame is a request-to-send or a high-efficiency multi-user request-to-send and the second frame is a clear-to-send, and wherein the method further comprises:
classifying the first frame as the intra-BSS frame if the first transmitter address matches a media access control (MAC) address of an access point the station is associated with.

21. An apparatus of a station comprising: a memory; and processing circuitry coupled to the memory, wherein the processing circuitry is configured to:
decode a first frame comprising a duration for a transmission opportunity;
determine to update a network allocation vector (NAV) based on the duration; and
store a basic service set (BSS) identification (ID)(BSSID) or a BSS color of the first frame associated with the NAV.

22. The apparatus of claim 21, wherein the processing circuitry is further configured to:
decode a second frame comprising a second duration for a second transmission opportunity, and further comprising a second BSSID or a second BSS color;
determine to update the NAV based on the second duration; and
store the second BSSID or the second BSS color of the second frame associated with NAV.

23. The apparatus of claim 21, wherein the processing circuitry is further configured to:
determine whether the first frame is an intra-BSS frame or an inter-BSS frame;
determine to update an inter-BSS NAV or an intra-BSS NAV based on the duration and whether the first frame is the intra-BSS frame of the inter-BSS frame;
store the BSSID or the BSS color associated with the inter-BSS NAV, if it is determined to update the inter-BSS NAV; and
store the BSSID and the BSS color associated with the intra-BSS NAV, if it is determined to update the intra-BSS NAV.

24. The apparatus of claim 21, wherein the processing circuitry is further configured to:
if the first frame does not include the BSSID or the BSS color, then store a receiver address of the first frame and a transmitter address of the first frame associated with the NAV.

25. The apparatus of claim 21, further comprising transceiver circuitry coupled to the memory; and, one or more antennas coupled to the transceiver circuitry.
